(19) United States
(12) Patent Application Publication
(10) Pub. No.: US 2008/0231588 A1
(43) Pub. Date: Sep. 25, 2008

(54) Avoiding Image Signal Being Interfered Method and Apparatus Thereof

(75) Inventor: Frankie Tsai, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HANNSTAR DISPLAY CORPORATION, Tao-Yuan Hsien (TW)

(21) Appl. No.: 11/778,225

(22) Filed: Jul. 16, 2007

(30) Foreign Application Priority Data
Mar. 21, 2007 (TW) 96109759

(51) Int. Cl. G09G 3/36

(52) U.S. Cl. 345/102

(57) ABSTRACT

The present invention provides a method for preventing an image signal from being interfered with an operation signal of a light source in a display. The method comprises adjusting the frequency of the operation signal to generate an operation signal spectrum, wherein the operation signal spectrum and the image signal spectrum of the image signal are arranged alternatively to each other.

### RELATED APPLICATIONS

This application claims priority to Taiwan Application Serial Number 96109759, filed Mar. 21, 2007, which is herein incorporated by reference.

### FIELD OF THE INVENTION

The present invention relates to a display and drive method thereof, and more particularly, to a display and drive method thereof that can overcome the interference from an image signal.

### BACKGROUND OF THE INVENTION

An inverter is a high voltage transformer that transforms a direct current to an alternating current to drive a light source of a display, such as a Cold Cathode Fluorescent Lamp (CCFL), a light-emitting diode (LED) or other kind of light source of a liquid crystal display.

Typically, there are two methods to drive an inverter to light a light source (Cold Cathode Fluorescent Lamp or LED, etc.), the Continue mode and the Burst mode. Taking the Cold Cathode Fluorescent Lamp for example, the continue mode drives the inverter to continually turn on the Cold Cathode Fluorescent Lamp. The Burst mode drives the inverter to periodically turn on the Cold Cathode Fluorescent Lamp. The power consumed in the Continue mode is larger than that consumed in the Burst mode. Therefore, the Burst mode drive method is the current trend.

However the high voltage requirements of the inverter in either the Continue mode or in the Burst mode, results in signal interference of the image of a display, especially at the moment the Cold Cathode Fluorescent Lamp is being turned on and turned off by the inverter. The interfered image signal displays an image with a waterfall phenomenon in the display.

Therefore, an inverter drive method that may not only reduce the power consumption but is also improve the image signal interference is required.

### SUMMARY OF THE INVENTION

Therefore, one of the objectives of the present invention is to provide an inverter drive method that improves the problem of a display image being interfered.

According to the above objective, a method for preventing the image signal from being interfered is provided. The method comprises adjusting the frequency of the operation signal of a light source in a display to generate an operation signal spectrum, wherein the generated operational signal spectrum and the image signal spectrum of an image signal for the display are arranged alternatively to each other.

According to the above objective, an apparatus for preventing an image signal from being interfered with is provided. The apparatus comprises a scalar controller to generate the operation signal based on a first signal, and an inverter coupling with the scalar controller to drive the light source base on the operation signal, wherein an operation signal spectrum is generated based on adjusting the frequency of the operation signal, and the generated operation signal spectrum and the image signal spectrum of a image signal for the display are arranged alternatively to each other.

Accordingly, the operation frequency spectrum of the inverter and the image signal spectrum are arranged alternatively. Therefore, the waterfall phenomenon in an image coming from the operation frequency interfering with the frequency of the image signal may be removed.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A and 1B illustrates a spectrum for an image signal that is transformed by a Fourier Transform method according to an embodiment of the present invention.

FIG. 2 illustrates a control circuit for an inverter according to an embodiment of the present invention.

FIG. 3 illustrates an operational flow chart according to an embodiment of the present invention.

### DETAILED DESCRIPTION OF THE PREFERRED EMBODIMENTS

A lot of different kinds of signals, such as voltage signals, frequency signals, power signals and so on, are involved in an image signal for a display device. The Fourier Transform method is a typical method to analysis this image signal. The Fourier Transform transforms an image signal from the time domain into the frequency domain. Therefore, the physical characteristic of the image signal in the frequency domain can be exhibited.

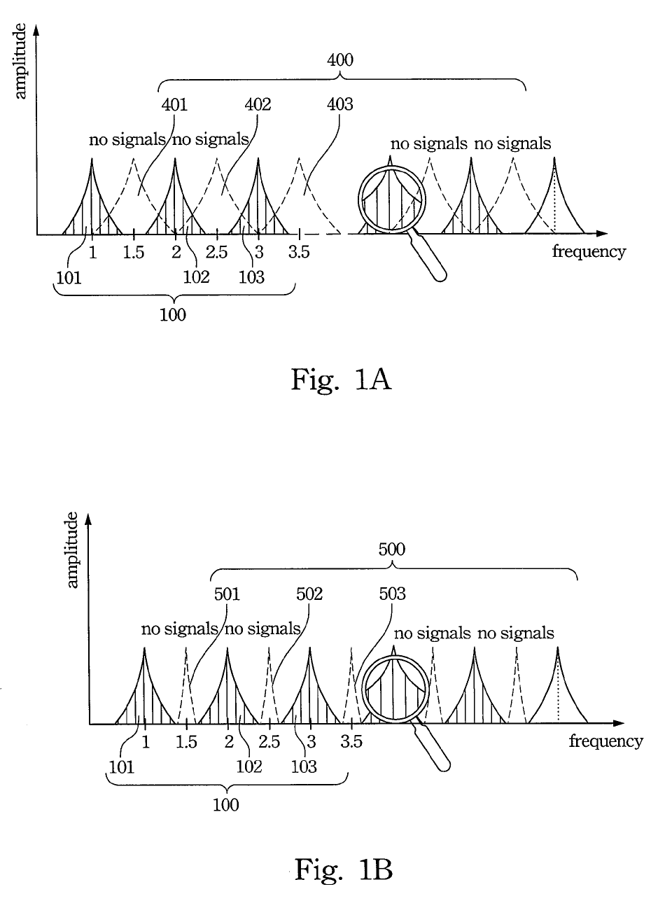

FIG. 1A illustrates the spectrum of an image signal transformed with a Fourier Transform according to an embodiment of the present invention. The transverse axis is the frequency and the vertical axis is the amplitude. The spectrum 100 of an image signal includes a plurality of spectrum signal 101, 102 and 103. In an embodiment, the frequency related to the largest amplitude of a spectrum signal is defined as the primary frequency. Further, in another embodiment, the primary frequency also can be defined as the average frequency of all the frequencies of a portion of the spectrum signal corresponding to a certain pre-set amplitude range. According to the above definitions and taking the first definition for example, the primary frequency of the spectrum signal 101 is 1 multiple frequency. The primary frequency of the spectrum signal 102 is 2 multiple frequency. The primary frequency of the spectrum signal 103 is 3 multiple frequency. The rest may be deduced by analogy.

According to the spectrum 100, no spectrum signals exist between any two adjacent spectrum signals. For example, no spectrum signal exist between the spectrum signal 101 and the spectrum signal 102. That is that a spectrum signal with a primary frequency of 1.5 multiple frequency doe not exist in the spectrum 100. Similarly, no spectrum signal exists between the spectrum signal 102 and the spectrum signal 103. That is that a spectrum signal with a primary frequency of 2.5 multiple frequency also doe not exist in the spectrum 100. Therefore, if the operation signal spectrum of an operation signal for the inverter for operating a light source and the image signal spectrum of the image signal are arranged alternatively, namely the spectrum signals of the operation signal spectrum 400 (as the dotted line portion shown) are sequentially located between two adjacent spectrum signals of the image signal spectrum 100, and the primary frequencies of the operation signal spectrum 400 and that of the image signal spectrum 100 do not overlap mutually, the waterfall phenomenon or other signal disturbance phenomenon in an image of a display device coming from the operation frequency of operation signal interfering with the image frequency of the image signal may be avoided or improved.

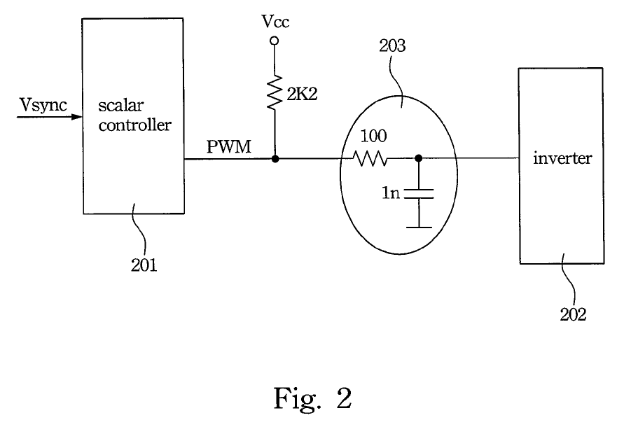

FIG. 2 illustrates a control circuit for an inverter according to an embodiment of the present invention. Inverter 202 is electrically coupled to a scalar controller 201. The scalar controller 201 is used to adjust the size of the display image based on the display panel. The control software of the scalar controller 201 may generate a pulse width modulation (PWM) signal based on the vertical synchronization signal (V_{sync}). The PWM signal is sent to the inverter 202 through the filter circuit 203 to periodically drive the light source (e.g. Cold Cathode Fluorescent Lamp, LED and so on) via the inverter. The filter circuit 203 receives the PWM signal and is used to filter a certain undesired signal frequency to output a filtered signal to the inverter.

According to the present invention, the operation signal spectrum of the operation signal of the inverter and the image signal spectrum of the image signal can be arranged alternatively, that is to say the spectrum signals of the operation signal spectrum are sequentially located between two adjacent spectrum signals of the image signal spectrum, or the primary frequencies of the operation signal spectrum and that of the image signal spectrum do not overlap mutually. Therefore, the waterfall phenomenon or other signal disturbance phenomenon in a display image coming from the operation frequency of operation signal interfering with the image frequency of the image signal may be avoided or improved. For example, in an embodiment, according to the spectrum of an image signal in FIG. 1, since no spectrum signal exist between the spectrum signal 101 and the spectrum signal 102 of the image signal spectrum 100, the first spectrum signal 401 of the operation signal spectrum 400 can be arranged in the location between the spectrum signal 101 and the spectrum signal 102 of the image signal spectrum 100. That is that the primary frequency of the spectrum signal 401 is 1.5 multiple frequency and does not overlap with the adjacent primary frequencies of the spectrum signal 101 and the spectrum signal 102. Also, the second spectrum signal 402 of the operation signal spectrum 400 can be arranged in the location where no spectrum signal of the image signal spectrum 100 exists, such as the location between the spectrum signals 102 and 103, and the rest spectrum signals is deduced by analogy. Through the above location arrangement of the operation signal spectrum 400, the generation of the waterfall phenomenon or other signal disturbance phenomenon can be avoided or improved. In another embodiment, the primary frequency of the spectrum signal 401 of the operation signal spectrum 400 can also be arranged in other locations that no spectrum signals of the image signal spectrum 100 exist, such as the location of the 2.5 multiple frequency of the image spectrum 100 or the location of the 3.5 multiple frequency of the image spectrum 100, etc. Similarly, the primary frequency of the spectrum signal 402 of the operation signal spectrum 400 can also be arranged in any other location that no spectrum signals of the image signal spectrum 100 exist, such as the location of the 5.5 multiple frequency of the image spectrum 100, etc., and the rest spectrum signals may be deduced by analogy.

According to the FIG. 1A, the operation signal spectrum 400 partially overlaps the image signal spectrum 100. However, in other embodiment, the operation signal spectrum may entirely separate from the image signal spectrum 100 as shown in the FIG. 1B. For example, the spectrum signal 501 of the operation signal spectrum 500 is arranged in the location between the spectrum signal 101 and the spectrum signal 102 of the image signal spectrum 100 and apart from the spectrum signal 101 and the spectrum signal 102.

In another embodiment, the time for scan signal of the scan lines of a display panel scanning from the top scan line to the button scan line is defined as one frame time. The time for scan signal scanning from the top scan line to the middle scan line is a half of one frame time. That is that the frequency for scanning from the top scan line to the middle scan line is two times as large as the frequency for scanning from the top scan line to the button scan line. In other words, when the frequency of the image signal is set to synchronize with the frequency of the scan signal, the frequency of the image signal is two times as large as the original frequency of the image signal. Therefore, in an embodiment, when the spectrum signal 401 of the operation signal spectrum 400 is between the spectrum signal 101 and the spectrum signal 102 of the image signal 100, for example, when the primary frequency of the spectrum signal 401 is 1.5 multiple frequency of the image spectrum 100, the vertical synchronization signal (V_{sync}) frequency inputted to the scalar controller 201 has to be enlarged to three times (1.5×2=3) as large as the original vertical synchronization signal (V_{sync}) frequency. The enlarged vertical synchronization signal (V_{sync}) frequency can control the scalar controller 201 to output the PWM signal frequency that is three times larger than the original PWM signal. The enlarged PWM signal is sent to the inverter 202 to periodically drive the light source of the display. At this time, the spectrum signal 401 of the generated operation signal spectrum 400 for the inverter is in the location between the spectrum signal 101 and the spectrum signal 102 of the image signal spectrum 100.

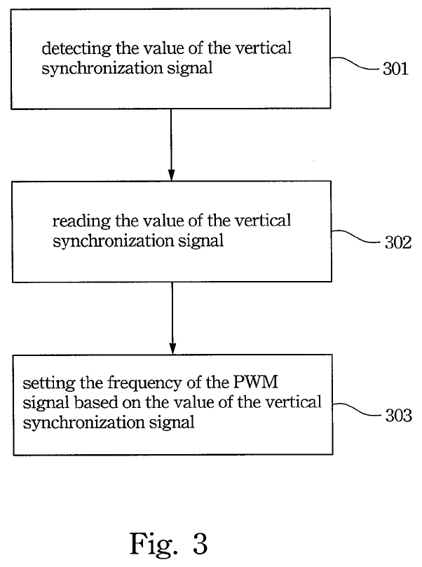

FIG. 3 illustrates an operation flow chart according to an embodiment of the present invention. Please refer to FIG. 1˜3. In step 301, the scalar controller 201 detects the value of the vertical synchronization signal (V_{sync}). In step 302, the value of the vertical synchronization signal (V_{sync}) is read out. In this embodiment, the spectrum signal 401 of the operation signal spectrum 400 is designed to be generated between the spectrum signal 101 and the spectrum signal 102 of the image signal spectrum 100, and the spectrum signal 402 of the operation signal spectrum 400 is generated between the spectrum signal 102 and the spectrum signal 103 of the image signal spectrum 100, and etc., to improve the waterfall phenomenon in an image. Since the frequency of the image signal for the display panel is two times as large as the original frequency of the image signal, the vertical synchronization signal (V_{sync}) frequency inputted to the scalar controller 201 can be modified to three times (1.5×2=3) as large as the original vertical synchronization signal (V_{sync}) frequency. The enlarged vertical synchronization signal (V_{sync}) may control the scalar controller 201 to output the PWM signal whose frequency is three times larger than that of the original PWM signal.

Accordingly, the operation signal spectrum for the inverter and the image signal spectrum are arranged alternatively to each other. Therefore, the waterfall phenomenon in an image coming from the frequency of the operation signal interfering with the frequency of image signal can be avoided or improved. Moreover, the spectrum signals as well as the other spectrum signals of the operation signal spectrum can be arranged at any location in the image signal spectrum where no spectrum signal exists. Furthermore, the location arrangement of the spectrum signals of the image signal spectrum can be changed in real time by modifying the value of the vertical synchronization signal (V_{sync}). Therefore, it is easy for the present invention to remove the waterfall phenomenon or other disturbance phenomenon.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for preventing an image signal from being interfered with an operation signal for a light source in a display, comprising:
adjusting the frequency of the operation signal to generate an operation signal spectrum, wherein the operation signal spectrum and the image signal spectrum of the image signal are arranged alternatively to each other.

2. The method as claimed in claim 1, wherein the spectrum signals of the operation signal spectrum are respectively and sequentially arranged between the spectrum signals of the image signal spectrum.

3. The method as claimed in claim 1, wherein the image signal spectrum includes a first spectrum signal and a second spectrum signal and the operation signal spectrum includes a third spectrum signal located between the first spectrum signal and the second spectrum signal of the image signal spectrum.

4. The method as claimed in claim 3, wherein the primary frequencies of the first spectrum signal, the second spectrum signal and the third spectrum signal are located without overlap mutually.

5. The method as claimed in claim 3, wherein the primary frequency of the third spectrum signal is 1.5 times as large as the primary frequency of the first spectrum signal.

6. The method as claimed in claim 3, wherein the primary frequency of the third spectrum signal is three times as large as the primary frequency of the first spectrum signal.

7. The method as claimed in claim 5, wherein the operation signal spectrum further includes a fourth spectrum signal, and the primary frequency of the fourth spectrum signal is 2.5 times as large as the primary frequency of the first spectrum signal.

8. An apparatus for preventing an image signal from being interfered with an operation signal for a light source in a display, comprising:
a scalar controller to generate an operation signal based on a first signal; and
an inverter coupling with the scalar controller to drive the light source base on the operation signal, wherein an operation signal spectrum is generated based on the frequency of the operation signal, and the operation signal spectrum and the image signal spectrum of the image signal are arranged alternatively to each other.

9. The apparatus as claimed in claim 8, wherein the first signal is a vertical synchronization signal.

10. The apparatus as claimed in claim 8, wherein the operation signal is a pulse width modulation signal.

11. The apparatus as claimed in claim 8, further comprises a filter, wherein the operation signal from the scalar controller is transmitted through the filter to the inverter.

12. The apparatus as claimed in claim 8, wherein the spectrum signals of the operation signal spectrum are respectively and sequentially arranged between the spectrum signals of the image signal spectrum of the image signal.

13. The apparatus as claimed in claim 8, wherein the image signal spectrum includes a first spectrum signal and a second spectrum signal and the operation signal spectrum includes a third spectrum signal located between the first spectrum signal and the second spectrum signal of the image signal spectrum.

14. The method as claimed in claim 13, wherein the primary frequencies of the first spectrum signal, the second spectrum signal and the third spectrum signal are located without overlap mutually.

15. The apparatus as claimed in claim 13, wherein the primary frequency of the third spectrum signal is 1.5 times as large as the primary frequency of the first spectrum signal.

16. The apparatus as claimed in claim 13, wherein the primary frequency of the third spectrum signal is three times as large as the primary frequency of the first spectrum signal.

17. The method as claimed in claim 15, wherein the operation signal spectrum further includes a fourth spectrum signal, and the primary frequency of the fourth spectrum signal is 2.5 times as large as the primary frequency of the first spectrum signal.

18. The method as claimed in claim 8, wherein the light source comprises a cold cathode fluorescent lamp or a light-emitting diode.
